(19) United States
(12) Patent Application Publication
(10) Pub. No.: US 2015/0305096 A1
(43) Pub. Date: Oct. 22, 2015

(54) METHOD FOR EXECUTING HEATING ACCORDING PROPERTY OF FOOD

(71) Applicant: CHING-CHUAN LIN, Chiayi County (TW)

(72) Inventor: CHING-CHUAN LIN, Chiayi County (TW)

(21) Appl. No.: 14/754,720

(22) Filed: Jun. 30, 2015

Related U.S. Application Data
(62) Division of application No. 14/061,759, filed on Oct. 24, 2013.

(51) Int. Cl. H05B 6/68; A23L 1/01; H05B 6/64

(52) U.S. Cl. CPC H05B 6/687; H05B 6/6441; H05B 6/6438; H05B 6/645; H05B 6/642; A23L 1/0128; A23V 2002/00

(57) ABSTRACT

A method for executing heating according to property of food is provided, in which a cooking appliance is provided with a reading device, a displaying screen, and a printing device. The cooking appliance forms a heating zone, which receives sensors and an ultrasonic scanner arranged therein. An object-to-be-heated is placed in the heating zone and the ultrasonic scanner scans and displays an outside configuration of the object on the displaying screen to allow a user to apply an automatic process or manual selection of a temperature difference between a single point or an average of multiple points for more than one or two points and another point for carrying out a heating operation. The sensors detect a temperature difference between a surface temperature and an interior temperature of the object in order to ensure that the temperature difference is kept constant.

### CROSS-REFERENCE TO RELATED APPLICATION

This is a division of the co-pending patent application Ser. No. 14/061,759, filed Oct. 24, 2013.

### (a) TECHNICAL FIELD OF THE INVENTION

The present invention generally relates to a method for executing heating according to property of food, and more particularly to a method that uses an ultrasonic scanner to scan and display an outside configuration of an object-to-be-heated on a displaying screen and to show the entire outside configuration of the food through three-dimensional rotation to allow a user to apply an automatic process or manual selection of a temperature difference of one point or any two points so as to make the difference between a surface temperature and an interior temperature constant thereby making heating or cooking of food more convenient and ensuring accomplishment of the ideal heating temperature and condition that a user desires and avoiding mistakes caused by human operation errors.

### (b) DESCRIPTION OF THE PRIOR ART

A regular cooking device, such as a microwave oven, can only provides a simple heating operation due to the structural limitation thereof. Referring to FIGS. 1A and 1B, for (I), the heating condition is set to be 80° C. for a period of 4 minutes and thus, the heating zone is the area (I) and the heating curve (L1) is a horizontal straight line; for (II), the heating condition is set to be 100° C. for a period of 6 minutes and thus, the heating zone is the area (IT) and the heating curve (L2) so induced is also a horizontal straight line. Thus, the conventional heating device is only capable of heating along a horizontal straight line (a single way or the only way of heating), where the heating temperature is kept at a fixed temperature of for example 80° C. or 100° C. as illustrated from the beginning to the end of the heating process. Since each type of food has its own and different property. Heating in a linear manner along a horizontal straight line will affect the taste of food and may lead to undercooling or overcooking of food if the setting is incorrect. Eventually, wastes of food, energy, and time may result. In view of these problems, the present invention aims to provide a method that executes heating according to the property of food so as to make cooking of food convenient and achieve the greatest utilization efficiency of energy, time and food to thereby serve as the best and most concern-free way of heating food.

### SUMMARY OF THE INVENTION

The primary object of the present invention is to provide a method for executing heating according to property of food, in which in heating food, an ultrasonic scanner completely scans and displays an outside configuration of an object-to-be-heated on a displaying screen, which is exhibited through three-dimensional rotation to allow a user to apply an automatic process (based on computer operation) or personal preference to temperature or other heating parameter to set a heating process and sensors are used to detect a temperature difference between a surface temperature and an interior temperature of the object-to-be-heated to ensure the temperature difference between the surface temperature and the interior temperature is kept constant thereby achieving the best compound heating effect in heating or cooking food and to provide a more convenient and more suitable way of cooking for exhibiting the sweet taste of food.

In the previous described method for executing heating according to property of food, a cooking appliance is provided with a reading device, a displaying screen, and a printing device for printing a barcode or a QR code. The cooking appliance forms therein a heating zone, which receive a plurality of sensors and an ultrasonic scanner arranged therein. To use, the object-to-be-heated is placed in the heating zone of the cooking appliance and the ultrasonic scanner completely scans and displays an outside configuration of the object-to-be-heated on the displaying screen to allow a user to apply an automatic process or manual selection of a temperature difference between a single point or an average of multiple points for more than one or two points and another point for carrying out a heating operation. The sensors are used to detect the temperature difference between a surface temperature and an interior temperature of the object-to-be-heated in order to ensure that the surface temperature and the interior temperature keep a constant temperature difference therebetween, thereby making heating or cooking of food more convenient and avoiding mistakes caused by human operation errors. Further, the cooking appliance records the manner of each heating operation, or information is stored in a computer for next use. When the best result of cooking has been obtained, the printing device of the cooking appliance prints out an object-to-be-identified, or coding is directly made and stored in the cooking appliance, whereby in the next use of the cooking appliance to heat the same object-to-be-heated, it only needs to use the reading device to read the object-to-be-identified or to make a direct activation through the coding.

In the previously described method for executing heating according to property of food, the object-to-be-identified printed out by the printing device of the cooking appliance is a barcode or a QR code, or other identifiable patterns or objects.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A and 1B illustrate heating curves of a conventional cooking device.

FIG. 2 is a perspective view showing a first embodiment of the present invention.

FIG. 3 is a schematic view showing the structure of the first embodiment of the present invention.

FIGS. 4 and 5 are schematic views illustrating the use of the first embodiment of the present invention.

FIG. 6 is a schematic view illustrating the first embodiment of the present invention connected to an external displaying screen.

FIG. 7 is a perspective view showing a second embodiment of the present invention.

FIG. 8 is a schematic view illustrating the use of the second embodiment of the present invention.

FIG. 9 is a plot showing a heating curve of the second embodiment of the present invention.

FIG. 10 is a plot showing a heating curve of a third embodiment of the present invention.

FIG. 11 is a schematic view illustrating the use of the fourth embodiment of the present invention.

FIG. 12 is a plot showing a heating curve of a fourth embodiment of the present invention.

FIG. 13 is a schematic view illustrating an embodiment for printing an object-to-be-identified according to the present invention.

FIG. 14 is a plot showing a heating curve of a fifth embodiment of the present invention.

FIG. 15 is a plot showing a heating curve of a sixth embodiment of the present invention.

FIG. 16 is a plot showing a heating curve of a seventh embodiment of the present invention.

FIG. 17 is a plot showing a heating curve of an eighth embodiment of the present invention.

FIG. 18 is a plot showing a heating curve of an eighth embodiment of the present invention.

FIG. 19 is a schematic view showing an embodiment of the present invention that includes a display screen mounted thereon.

FIG. 20 is a schematic view showing an embodiment of the present invention that includes a display screen connected thereon.

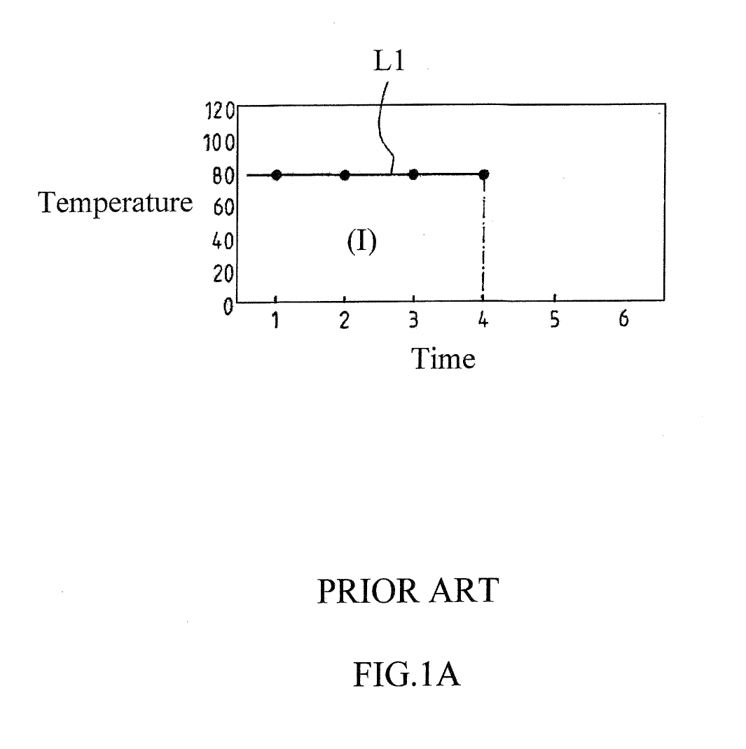

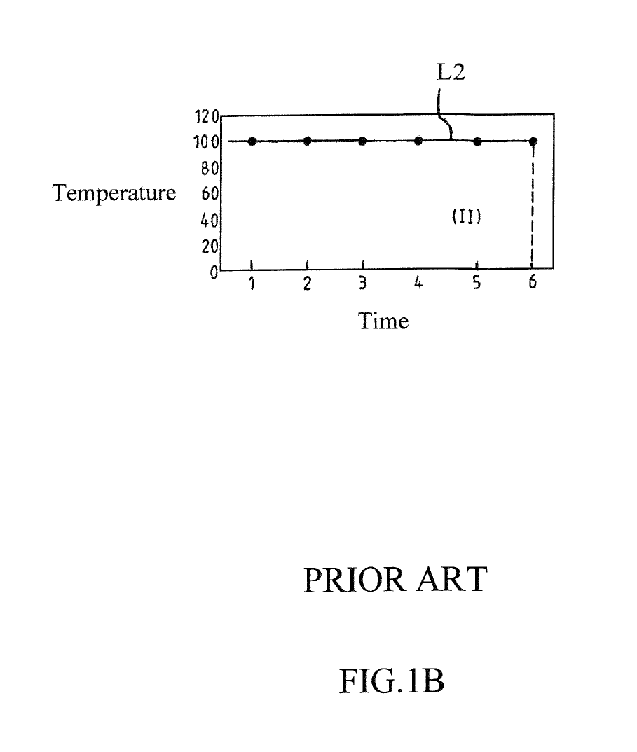

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

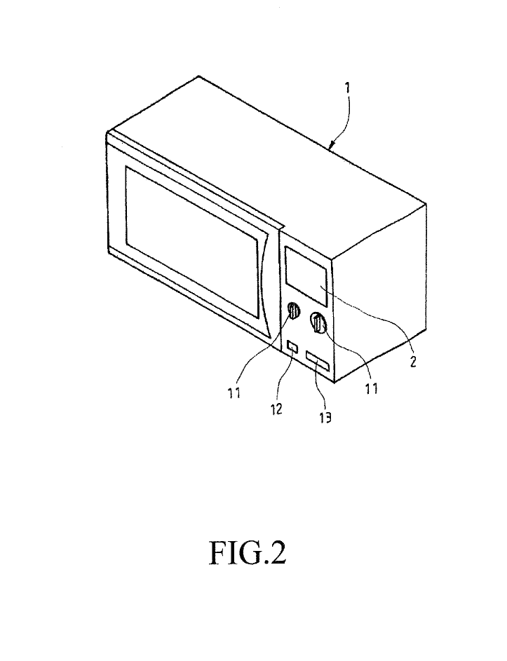

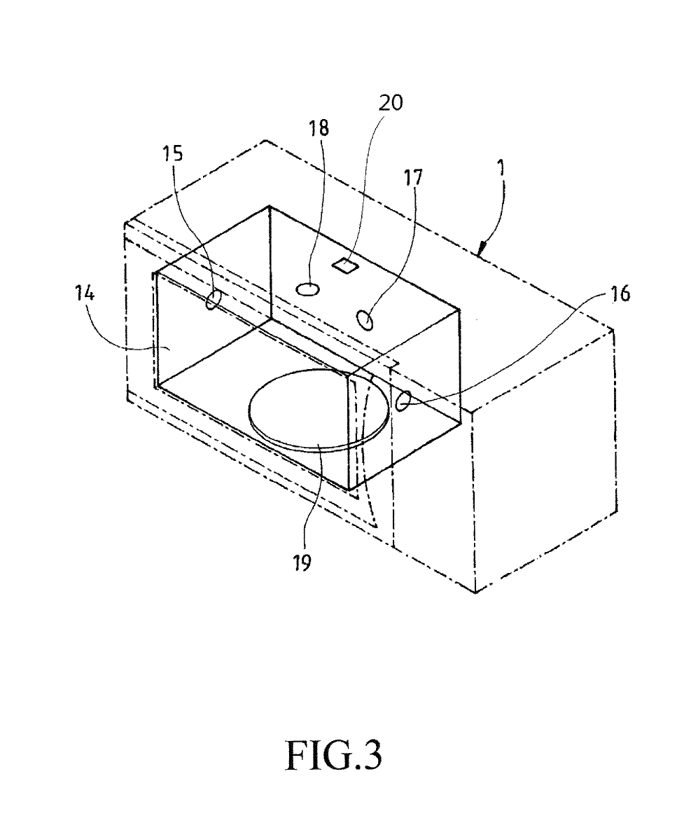

Referring to FIGS. 2 and 3, which are respectively a perspective view and a schematic view showing a first embodiment according to the present invention, as shown in the drawings, the present invention generally comprises a cooking appliance 1 for heating (which in the instant embodiment is a microwave oven comprises operation knobs 1). The cooking appliance 1 comprises a reading device 12 and a displaying screen 2 (for example an liquid crystal display (LCD) or an light-emitting diode (LED) displaying screen, such as a touch display), and a printing device 13 for printing a barcode or a QR code. The reading device 12 is a barcode scanner, which is mounted on the cooking appliance 1 in such a way that a reading terminal is exposed outside the cooking appliance 1. The cooking appliance 1 comprises a heating zone 14 formed therein and receiving a plurality of sensors 15, 16, 17, 18, a rotary tray 19, and an ultrasonic scanner 20 arranged therein. In the instant embodiment, the sensors 15, 16, 17, 18 comprise temperature detection elements. The sensors 15, 16 are respectively mounted at opposite lateral sides of the heating zone 14. The sensor 17 is mounted at a rear side of the heating zone 14. The sensor 18 is arranged at the top side of the heating zone 14 (or is additionally mounted at other suitable locations, such as the bottom plate).

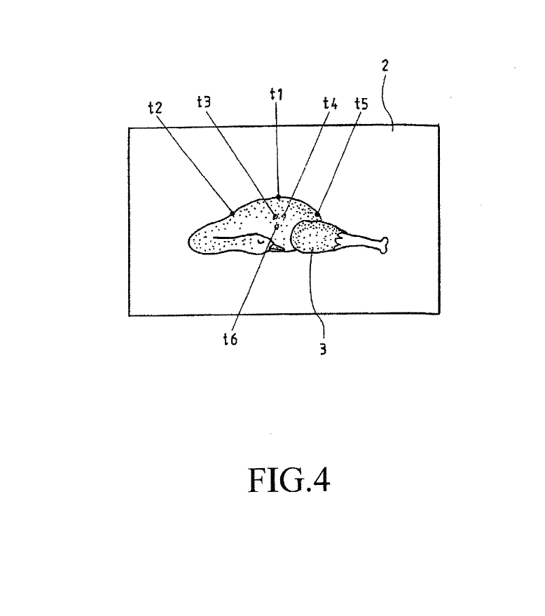

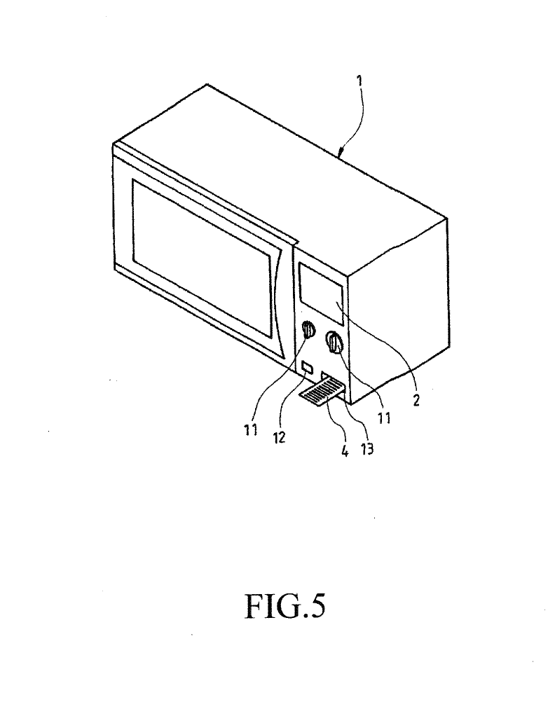

Referring to FIGS. 4 and 5, which are schematic views illustrating the use of the first embodiment according to the present invention, reference being also had to FIG. 3, as shown in the drawings, to use the present invention, an object-to-be-heated 3 is placed on the rotary tray 19 in the heating zone 14 of the cooking appliance 1. The ultrasonic scanner 20 completely scans an outside configuration of the object-to-be-heated 3 to be displayed on the displaying screen 2 in a three-dimensional and rotatable manner to allow a user to select, through a touch-to-control operation performed on the displaying screen 2, automatic heating or optional heating (by selecting one point or multiple point average for more than one or more than two or temperature difference with respect another point, the ways of selection including (1) selecting a single point (a point on a surface of a center point) to set heating temperature, (2) selecting multiple points (two points or more than two points on the surface or a point on the surface and the center point) to set heating temperature, (3) setting a temperature difference between surface temperature and internal (center point) temperature for heating, (4) setting temperature difference between arbitrary two points for heating). In other words, temperature of one location can be selected and set by means of the displaying screen 2 and the relative relationship thereof with respect to another location and multiple other locations can also be set. Taking the duck shown in FIG. 4 as an example, the temperature (t1) of the duck back, the temperatures (t2, t3, t4, t5) of four points around the duck, and the temperature (t6) of the interior of the duck can be selected and set in the ways described below:

(1) setting t1=100° C. (surface temperature), t6=90° C. (interior temperature)

t1−t6=100° C.−90° C.=10° C. (temperature difference)

where after the selection of the temperatures of the two points (temperature difference being 10° C.) and confirmation of the selection, the cooking appliance 1 automatically starts to heat until the set conditions are reached where the heating stops.

(2) setting average temperature of t1, t2, t3, t4 (surface temperature)

(t1+t2+t3+t4+t5)/5=t′=100° C.

setting interior temperature t6=85° C.

r=t′−t6=100° C.−85° C.=15° C. (temperature difference),

where heating is carried out automatically.

(3) setting temperature difference between t2 and t4, t″=0° C., t2=100° C., t4=100° C.,

where heating is automatically shut down once t2 and t4 reach the set temperatures.

According to the present invention, the setting can be done through unlimited selections and all sorts of final (user's preferred) heating temperature and condition can be set as desired, whereby, when used in combination with the ultrasonic scanner 20, an optimum heating result can be obtained. Further, the present invention provide an operation that is easy and allows a user to select, among high heating 100° C., medium heating 85° C.-99° C., or low heating below 84° C., the temperature of any point or a temperature difference of a point with respect to any other point or points from according to the user's preference of food in order to achieve automatic execution of heating. For example:

(1) After the conditions that t1=100° C., t3=95° C., and t6=85° C. are set, heating can be executed immediately.

(2) After the conditions that t5=105° C. and t4=100° C. are set, heating can be executed immediately without setting the interior temperature.

After the execution of the above descried heating operations, the cooking appliance 1 records the manner of each heating or stores the information in a computer, whereby after the best result of cooking has been achieved, the printing device 13 of the cooking appliance 1 prints out an object-to-be-identified 4 (a barcode or a QR code) or coding is carried out and is directly stored in the cooking appliance. Thus, in the next use of the cooking appliance 1 to heat a similar object-to-be-heated 3, it only needs to use the reading device 12 to read the object-to-be-identified 4 or to perform direct activation through the coding, so that the operation is made easy and efficient.

The present invention provides standards to any object-to-be-heated 3, especially for an irregular object-to-be-heated 3 (such as chicken, duck, fish, fruit/vegetable, which is an object-to-be-heated 3 that is not re-composed or standardized), wherein each type of object-to-be-heated 3 has different weight and size and the heating conditions are accordingly different. Thus, the present invention can provide the optimum efficiency and the best personalized heating condition. Further, the present invention can learn the best heating value (heating parameter) through the accumulation of experiences of multiple times of operations so as to provide the user with the best heating conditions.

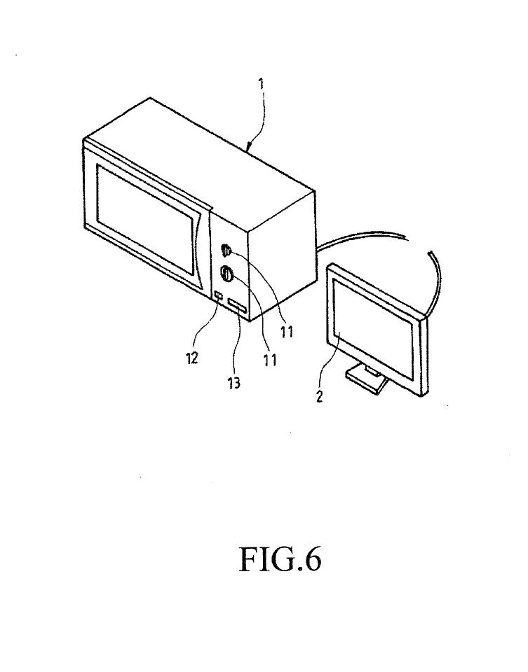

Referring to FIG. 6, which is a schematic view illustrating the first embodiment of the present invention connected to an external displaying screen, as shown in the drawing, the present invention allows a displaying screen 2 to externally connected to the cooking appliance 1 so that the displaying screen 2 may display the outside configuration of the object-to-be-heated 3 to be observed by the user.

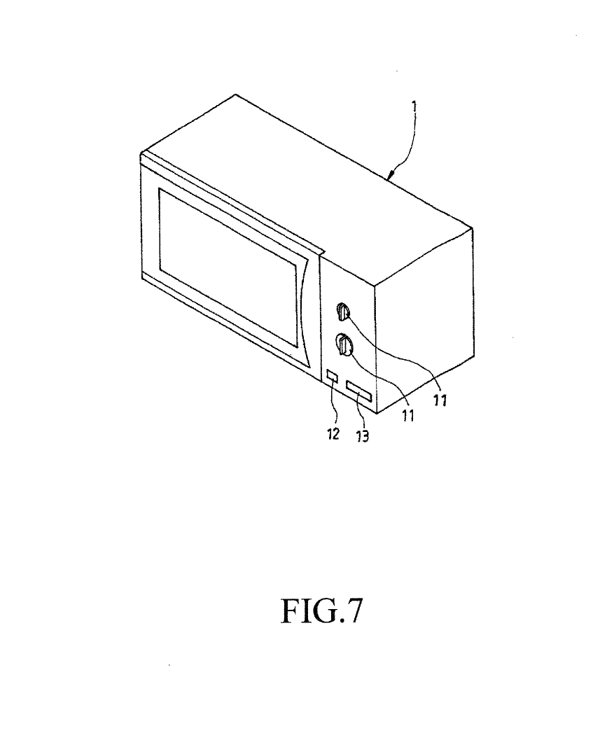

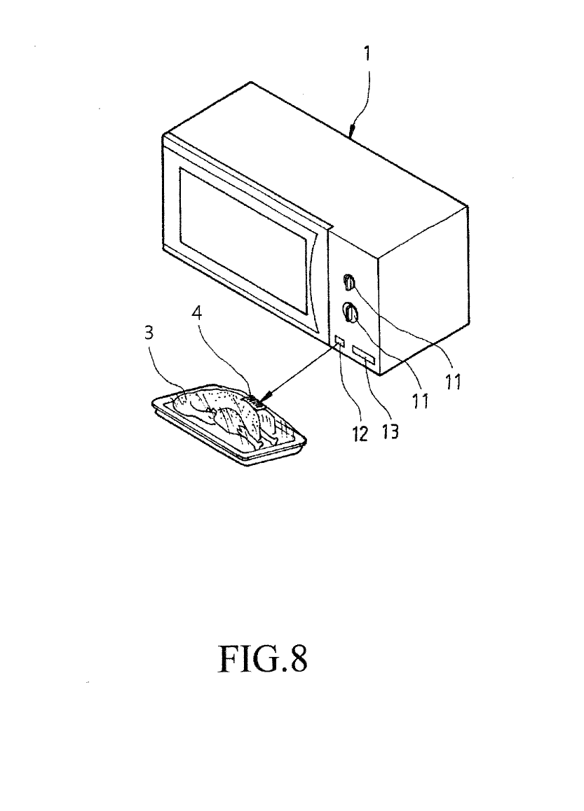

Referring to FIGS. 7 and 8, which are respectively a perspective view of and a schematic view illustrating the user of a second embodiment according to the present invention, as shown in the drawings, the present invention generally comprises a cooking appliance 1 for heating (which in the instant embodiment is a microwave oven comprises operation knobs 1) and an object-to-be-identified 4 that is directly printed on or is attached to an object-to-be-heated 3 (which is a foodstuff to be heated by microwaving and the package thereof) and contains temperature, time, and other heating parameters including water content, humidity, roasting, and smoking. The cooking appliance 1 comprises a reading device 12 for reading the object-to-be-identified 4 and a printing device 13 for printing a barcode or a QR code. The reading device 12 is a barcode scanner, which is mounted on the cooking appliance 1 in such a way that a reading terminal is exposed outside the cooking appliance 1. The cooking appliance 1 comprises a heating zone 14 formed therein and receiving a plurality of sensors 15, 16, 17, 18, and a rotary tray 19 arranged therein. In the instant embodiment, the sensors 15, 16, 17, 18 comprise temperature detection elements (see FIG. 3). The sensors 15, 16 are respectively mounted at opposite lateral sides of the heating zone 14. The sensor 17 is mounted at a rear side of the heating zone 14. The sensor 18 is arranged at the top side of the heating zone 14 (or is additionally mounted at other suitable locations).

The object-to-be-identified 4 comprises a barcode that is set up according to the above described factors, including temperature, time, and other parameters of water content, humidity, roasting, and smoking, or a QR code, or any other identifiable patterns or objects. These parameters are (heating) parameters that can provide the best quality of a food product to be heated (in a compound heating process) set up by the manufacturer of the food product.

With the above arrangement, the reading device 12 reads the contents of the object-to-be-identified 4 and comparison is made with a control program to allow the control program to drive the cooking appliance 1 to execute automatic heating according to data of temperature and time set up in the object-to-be-identified 4; and the sensors 15, 16, 17, 18 detect a temperature difference between a surface temperature and an interior temperature of the object-to-be-heated to automatically set up the heating process so as to keep constant the temperature difference between the surface temperature and the interior temperature and make heating or cooking of food more easily and avoids any mistakes caused by human operation errors.

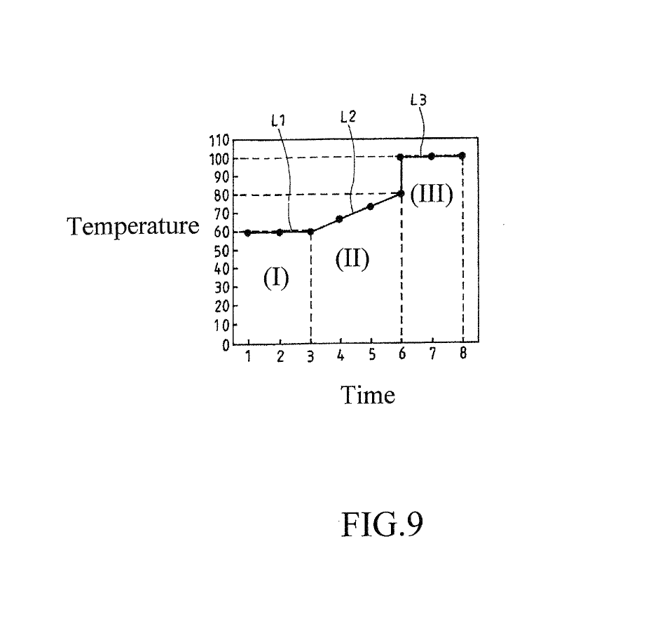

Referring to FIG. 9, which is a plot showing a heating curve of the second embodiment of the present invention, as shown in the drawing, to use the present invention, after the reading device 12 is operated to read and compare the contents of the object-to-be-identified 4 with a control program, the control program drives the cooking appliance 1 to execute automatic heating according to temperature and time (and other heating parameters) set up in the object-to-be-identified 4 so that various applications having stages of different temperature and time can be achieve:

(A) The first stage-thaw stage: set conditions are temperature 60° C. for a period of time of 3 minutes.

(B) The second stage-slow temperature rise stage: set conditions are temperature increasing from 60° C. to 80° C. for a period of time of 3 minutes.

(C) The third stage-fast heating stage: set conditions are temperature 100° C. for a period of time of 2 minutes.

The combination of the above stages is a heating curve that starts from L1 to L2 and then to L3 and that in entirety is not a horizontal straight line and is the best heating condition designed to meet the needs of a product and is a heating design that allows of the best use of thermal energy and is most efficient. Three different stages of heating is provided according to the heating conditions that completely suits the property of the product and personal requirements and the temperatures can be set according to the needs of these stages, such as heating by a constant temperature or increasing (the best heating condition, such as being slow or fast or parabola) or decreasing temperature.

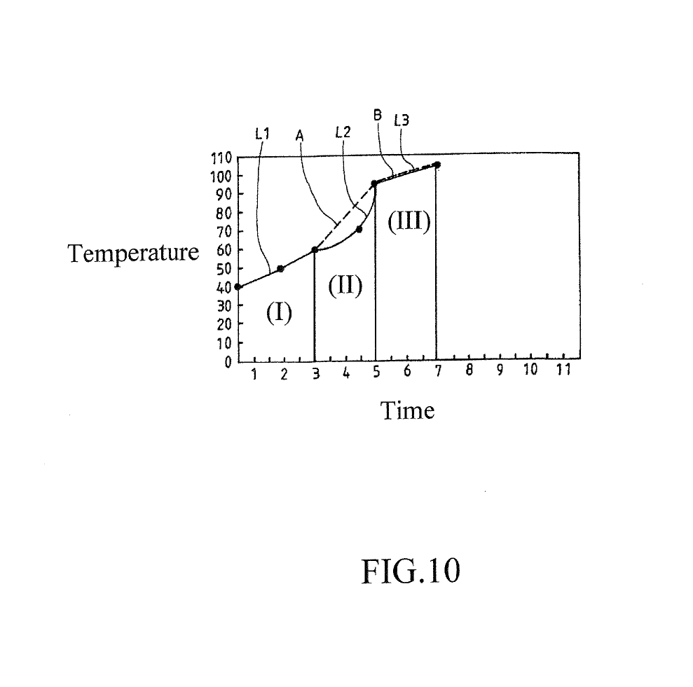

Referring to FIG. 10, which is a plot showing a heating curve of a third embodiment of the present invention, as shown in the drawing, the present invention can be set according to product property (or personal preference):

(A) The first stage (I)—heating conditions (thaw and heating line L1): temperature 40° C., time 3 minutes (0-3 minutes).

(B) The second stage (II)—heating conditions being two alternatives: (1) heating and (2) humidifying (parameter A).

(1) Curved heating line L2: temperature from 60° C. to 95° C., time 2 minutes (3-5 minutes).

(2) simultaneously activating “humidifying”: humidity percentage % being set up by the user (from 0% to 100% according to product property), time 2 minutes or set by the user.

(C) The third stage (III)—heating conditions being two alternatives: (1) heating and (2) and smoking (parameter B).

(1) heating temperature from 95° C. to 105° C.

(2) simultaneously activating smoking operation, in which concentration percentage % is set according to the requirement of the product (or personal preference).

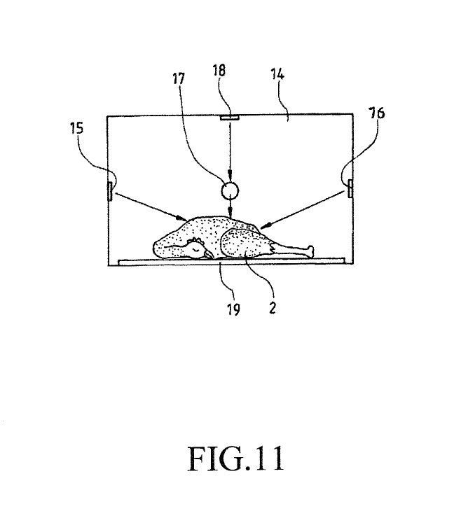

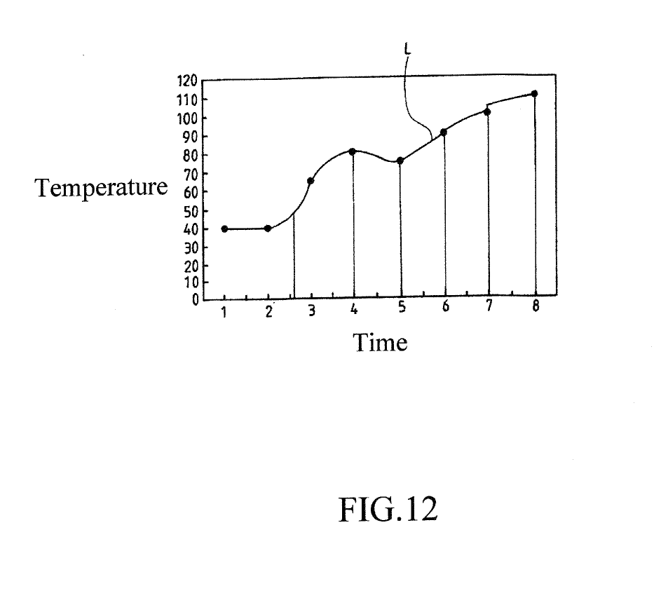

Referring to FIGS. 11 and 12, which are respectively a schematic view illustrating the use of a fourth embodiment according to the present invention and a heating curve thereof, as shown in the drawings, the present invention uses the sensors 15, 16, 17, 18 to detect a temperature difference a surface temperature and an interior temperature of an object-to-be-heated 3 in order to automatically set up a heating process for keeping a constant temperature difference between the surface temperature and the interior temperature, whereby according the best heating characteristics of the product, during the entire heating process, the difference of “surface temperature—interior temperature” is kept less than 10° C.+/−1° C., the temperature difference being around 10° C., until the surface temperature reaches 100° C., which means the interior temperature is within the range of 90° C.+/−1° C. with which heating is executed. The present invention directly activates the sensors 15, 16, 17, 18 to keep the difference between the surface temperature and the interior temperature in the temperature difference range of 10° C., by which the heating operation is carried out to reach the set surface temperature of 105° C. The heating curve follows (average) temperature difference C″=(C2+C3+C4)/3−C1≦10° C. to provide an optimum automatic heating curve, in which:

(a) The sensor 18 generally functions to detect the interior temperature (C1) of the object-to-be-heated 3.

(b) The sensors 15, 16, 17 function to detect the surface temperatures (C2, C3, C4) of the object-to-be-heated 3.

(c) The average surface temperature C′ is an average of the temperatures detected by the three side sensors 15, 16, 17, namely (C2+C3+C4)/3=C′, and C′−C1=C″, which is the temperature difference, whereby according to the instant embodiment, C″≦10° C. and at the end of the heating process, the surface temperature C′=105° C., the average surface temperature=interior temperature C1≦10° C. for the process from the start to the end, and alternatively, other parameters can be set up, if desired, such as rotating speed (RPM) of the rotary tray 19.

Assuming, for a frozen (at −18° C.) roasted chicken, the best heating (compound heating) condition can be set up after multiple test carried out manually, and a heating process is provided as indicated by the “L” curve shown in FIG. 12 with all sorts of functions are activated in all stages. After the reading device 12 scans the object-to-be-identified 4 provided on a package of the object-to-be-heated 3, the frozen roasted chicken is placed in the cooking appliance 1 and then, the cooking appliance 1 automatically activates the functions of each of the stages to achieve a desired result.

Besides the heating function discussed above, the present invention also provides the following special functionalities:

(1) Microwaving function: which can be an intermittent manner or can be set constantly at an “ON” condition from the start to the end.

(2) Steaming function: this function provides effects of temperature-keeping (humidity-keeping) to avoid surface scorching of the object-to-be-heated caused by being kept in a condition of high temperature for a long time and thus prevent poor result of the product caused thereby.

(3) Smoking function: when heating and temperature-keeping is performed with steam, the sweet smell of previously performed smoking operations may get volatized and the smell of smoking get diluted and this function help supplementing the flavor to keep the sweet smell.

(4) Roasting function: roasting can be finally applied to remove humidity so as to reproduce surface smell and taste of the product that can be perceived before the product is frozen (the original smell and taste).

(5) Rotating function of the rotary tray: the optimum rotating speed can be set for each stage through automatic or manual setting operation in order to coordinate with the activations of other functions to provide the best result.

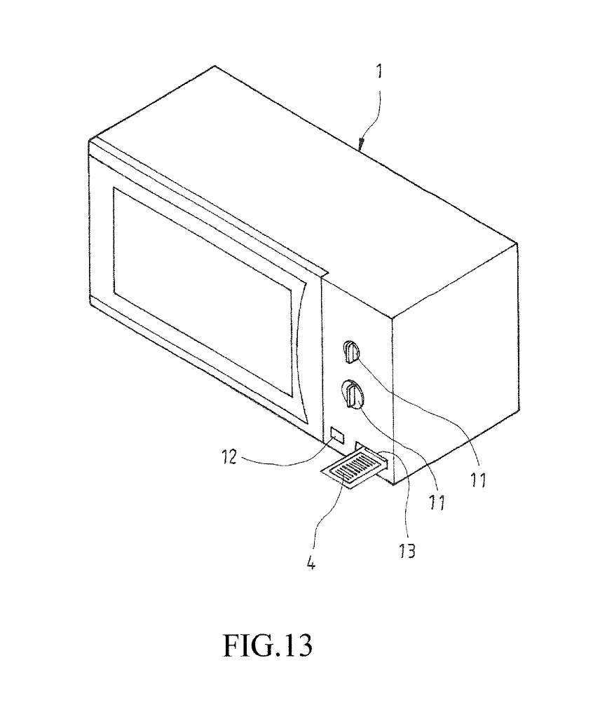

Referring to FIG. 13, which is a schematic view illustrating an embodiment for printing an object-to-be-identified according to the present invention, as shown in the drawing, the present invention allows a user to set up, in the cooking appliance 1, the best heating way by himself or herself and allows the cooking appliance 1 to record the manner of each heating operation so that, after the best result of cooking is identified, the printing device 13 of the cooking appliance 1 may be operated to print out an object-to-be-identified 4 (a barcode or a QR code). In the next use of the cooking appliance 1 to heat an identical product of the object-to-be-heated 3, it only needs to use the reading device 12 to read the object-to-be-identified 4 so that the operation is made easy and efficient.

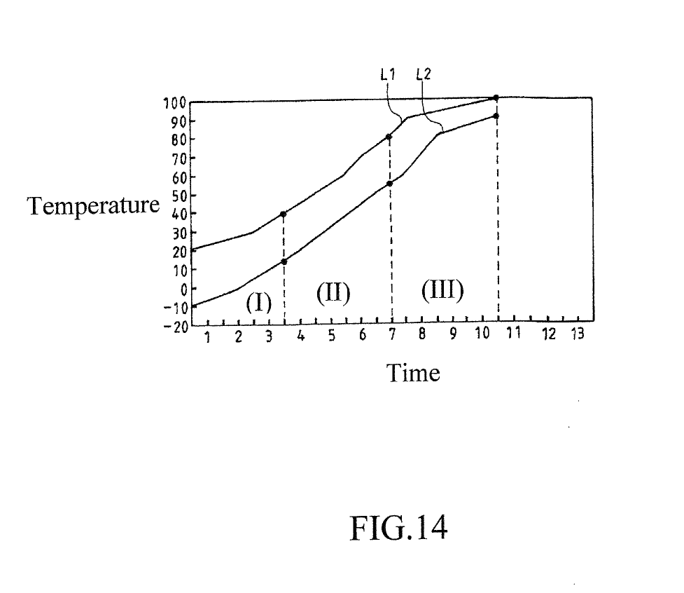

Referring to FIG. 14, is a plot showing a heating curve of a fifth embodiment of the present invention, as shown in the drawing, besides identifying an object-to-be-identified 4 for carrying out heating, the present invention can be set, by a compelling system, to an automatic navigation mode, wherein a desired heating time is first set and then the control program drives the cooking appliance 1 to execute automatic heating according to the set time. Then, the sensors 15, 16, 17, 18 are used to detect a temperature difference between the surface temperature (L1) and the interior temperature (L2) of the object-to-be-heated to automatically achieve a stage-wise heating process (first, second, and third stages) so as to accomplish that when the temperature difference between the surface temperature and the interior temperature reaches a fixed value (such as surface temperature being 100° C. and the interior temperature being at a temperature difference of 10° C. with respect thereto), the heating operation is automatically stopped, whereby heating or cooking a food product is made easier and mistakes caused by human operation errors can be avoided.

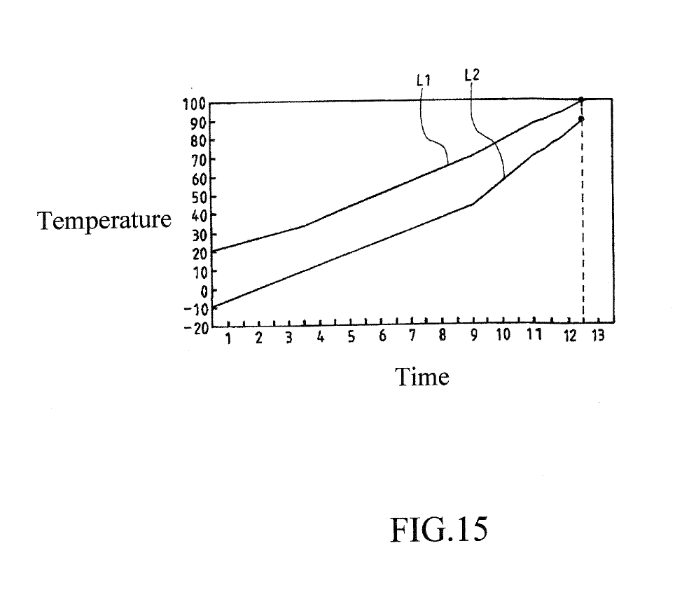

Referring to FIG. 15, which is a plot showing a heating curve of a sixth embodiment of the present invention, as shown in the drawing, besides identifying an object-to-be-identified 4 for carrying out heating, the present invention can be set, by a compelling system, to a compelled navigation mode, wherein the surface temperature (L1) and the interior temperature (L2) are first set and the control program drives the cooking appliance 1 to execute automatic heating according to the set temperatures. Then, the sensors 15, 16, 17, 18 are used to detect a temperature difference between the surface temperature and the interior temperature of the object-to-be-heated to automatically set up a heating process and achieve (the set single point or temperature or average temperature of multiple points) the set temperatures of the surface temperature and interior temperature by which the heating operation is automatically stopped, whereby heating or cooking a food product is made easier and mistakes caused by human operation errors can be avoided.

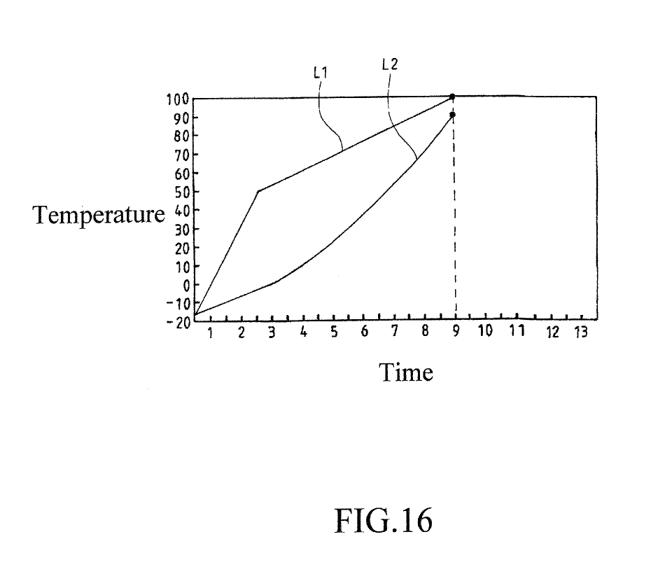

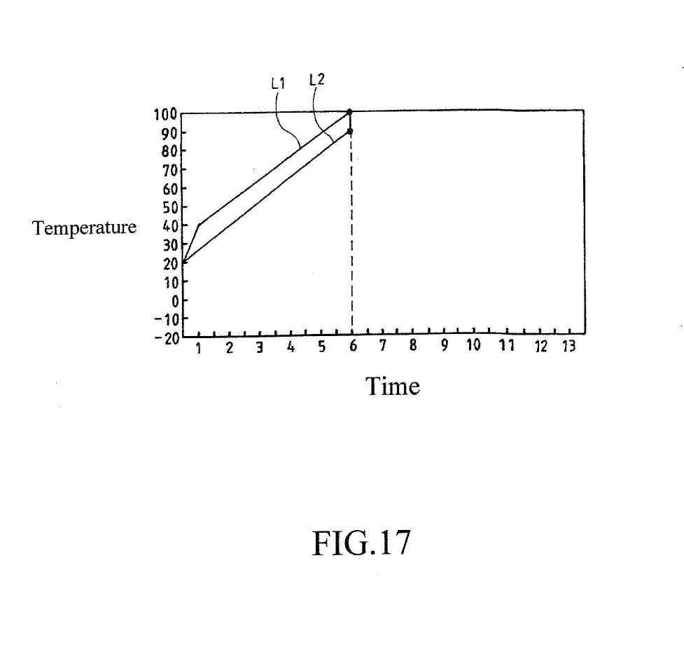

Referring to FIGS. 16 and 17, which are respectively plots showing heating curves of a seventh and an eighth embodiments of the present invention, as shown in the drawings, besides identifying an object-to-be-identified 4 for carrying out heating, the present invention allows a user to set a heating mode by himself or herself, wherein a temperature difference (10° C.) between the surface temperature (L1) and the interior temperature (L2) is first set and a control program drives the cooking appliance 1 to execute automatic heating according to the set temperatures. Then, the sensors 15, 16, 17, 18 are used to detect the temperature difference between the surface temperature and the interior temperature of the object-to-be-heated for automatically setting up a heating process, whereby when the surface temperature and the interior temperature reach the set temperature difference, the heating operation is automatically stopped thereby making heating or cooking of food product more convenient.

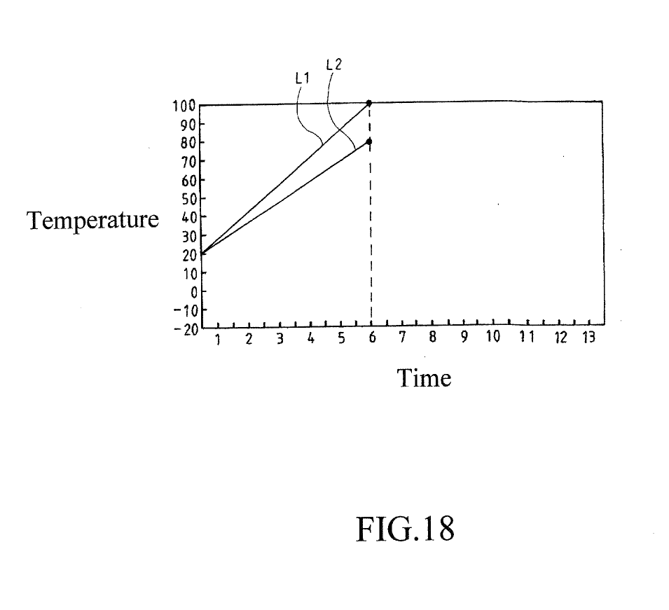

Referring to FIG. 18, which is a plot showing a heating curve of a ninth embodiment of the present invention, as shown in the drawing, besides identifying an object-to-be-identified 4 for carrying out heating, the present invention allows a user to set a heating mode by himself or herself, wherein a temperature difference (20° C.) between the surface temperature (L1) and the interior temperature (L2) is first set and a control program drives the cooking appliance 1 to execute automatic heating according to the set temperatures. Then, the sensors 15, 16, 17, 18 are used to detect the temperature difference between the surface temperature and the interior temperature of the object-to-be-heated for automatically setting up a heating process, whereby when the surface temperature and the interior temperature reach the set temperature difference, the heating operation is automatically stopped thereby making heating or cooking of food product more convenient.

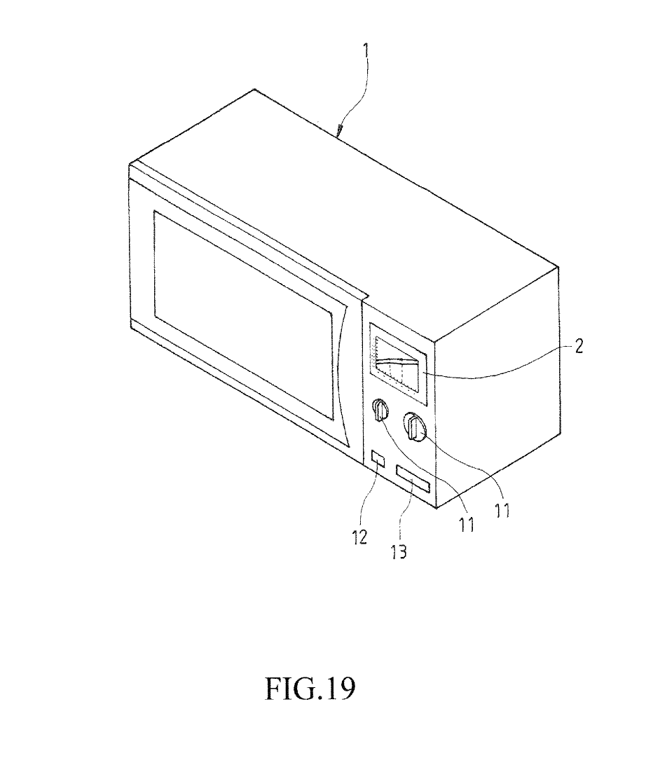

Referring to FIG. 19, which is a schematic view showing an embodiment of the present invention that includes a display screen mounted thereon, as shown in the drawing, the present invention may comprise a displaying screen 2 (an LCD or an LED displaying screen) mounted to the cooking appliance 1. The displaying screen 2 can display the heating curve to be observed by a user and to convert the curve into an object-to-be-identified 4 that can be printed out (as a barcode or a QR code) by means of the printing device 13 of the cooking appliance 1. Thus, when other users make scanning of the object-to-be-identified 4 for use, the displaying screen 2 may display an image of the curve. As such, a subsequent user, when considering the final temperature is excessively high or low, may refer to the data of the previous user for altering the settings for execution of heating and re-print out the object-to-be-identified 4 for subsequent uses thereby making it suit the needs of different users. For example, family members of different ages may have different preference of food taste (temperature or humidity or other heating parameters) and the present invention allows of modification and setting according to personal preference so as to suit the needs of each individual.

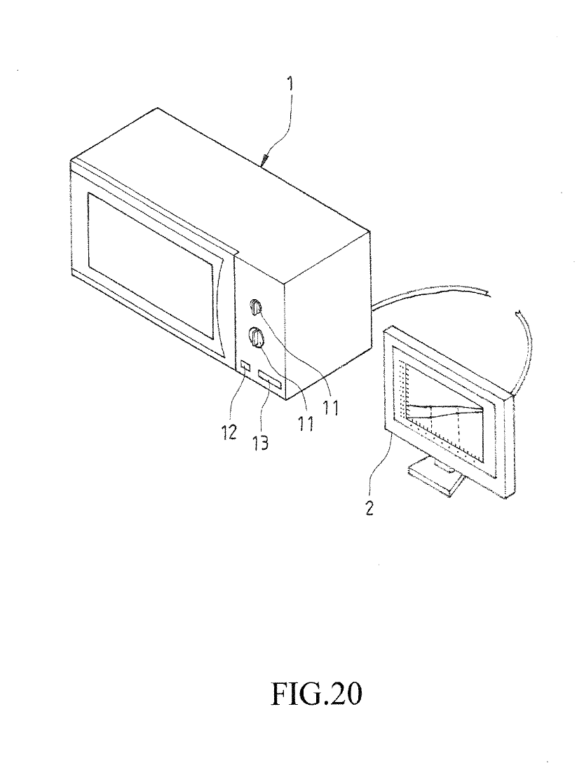

Referring to FIG. 20, which is a schematic view showing an embodiment of the present invention that includes a display screen externally connected thereon, as shown in the drawing, the present invention comprises a displaying screen 2 (an LCD or an LED displaying screen) to be externally connected to the cooking appliance 1, so that the displaying screen 2 can display the heating curve to be observed by a user and to convert the curve into an the object-to-be-identified 4 that can be printed out (as a barcode or a QR code) by means of the printing device 13 of the cooking appliance 1.

Compared to the conventional cooking appliance, the present invention provides at least the following advantages:

(1) An ultrasonic scanner is used to completely scan the outside configuration of an object-to-be-heated to be displayed on a displaying screen, so that a user may uses a touch-to-control manner to select automatic heating on the displaying screen, thereby making heating or cooking of food more convenient.

(2) A user may use a touch-to-control manner to select, on a displaying screen, a single point (a point on surface or an interior point) for setting of a temperature of heating, thereby making heating or cooking of food more convenient.

(3) A user may use a touch-to-control manner to select, on the displaying screen, multiple points (two points or more than two points on surface or a point on the surface and a center point) for setting of temperatures of heating.

(4) A user may use a touch-to-control manner to select, on the displaying screen, a temperature difference between a surface temperature and an interior (center) temperature to set heating.

(5) A user may use a touch-to-control manner to select, on the displaying screen, a temperature difference between any two points to set heating.

(6) The cooking appliance records the manner of each heating operation and the information is stored in a computer and a printing device of the cooking appliance may print out an object-to-be-identified (a barcode or a QR code), so that in the next use of the cooking appliance for heating an identical product of the object-to-be-heated, execution can be achieved through a reading device reading the object-to-be-identified thereby making the operation more convenient and more efficient.

(7) The cooking appliance records the manner of each heating operation and the information is directly coded and stored in the cooling appliance, so that in the next use of the cooking appliance for heating an identical product of the object-to-be-heated, execution can be achieved through activation with the coding thereby making the operation more convenient and more efficient.

(8) A compelling system can be used to set up an automatic navigation mode, so that when the temperature difference between a surface temperature and an interior temperature become constant, the heating operation is automatically stopped whereby mistakes caused by human operation errors can be avoided.

(9) A compelling system can be used to set up a compelled navigation mode, so that when a surface temperature and an interior temperature reach set temperatures, the heating operation is automatically stopped whereby mistakes caused by human operation errors can be avoided.

(10) A user is allowed to set up a heating mode by himself or herself so that when a surface temperature and an interior temperature reach set temperatures, the heating operation is automatically stopped, thereby making heating or cooking of food more convenient.

(11) A displaying screen (such as an LCD or an LED displaying screen) can be mounted to the cooking appliance and the displaying screen may display a heating curved to be observed by a user and to convert it into an object-to-be-identified to be print out (as a barcode or a QR code) by a printing device of the cooking appliance, whereby when other users make scanning of the object-to-be-identified for use, the displaying screen may display an image of the curve and as such, a subsequent user, when considering the final temperature is excessively high or low, may refer to the data of the previous user for altering the settings for execution of heating and re-print out the object-to-be-identified for subsequent uses thereby making it suit the needs of different users.

(12) The present invention provides standards to any object-to-be-heated, especially for an irregular object-to-be-heated (such as chicken, duck, fish, fruit/vegetable, which is an object-to-be-heated that is not re-composed or standardized) and since each type of object-to-be-heated has different weight and size, the heating conditions are accordingly different and the present invention can provide the optimum efficiency and the best personalized heating condition and the present invention can learn the best heating value (heating parameter) through the accumulation of experiences of multiple times of operations so as to provide the user with the best heating conditions.

(13) The same user and the same object-to-be-heated can set different heating temperatures according to different seasons or time in order to fully suit the needs of the user, meaning the present invention allows of setting of heating temperature according to any requirements to provide a customization effect.

(14) The conventional barcode-scanning based heating technology only sets up conditions of temperature and time; however, the same object-to-be-heated is heated at different temperature and time will give totally different results (the results of heating being totally different for the same object-to-be-heated heated under the condition of 18° C. and that of 20° C., for example: a frozen object-to-be-heated and a thawed object-to-be-heated being heated with the same way of heating through barcode scanning, wherein due to the required conditions of heating temperature and time are different between the two, it may result in moderate heating result or over-heating), and thus, the present invention provides automatically-navigated heating for the object-to-be-heated according to the desired final condition and this cannot be achieved by the conventional barcode-scanning based heating technology.

(15) During a heating process, if heating is paused due to some reasons, the present invention allows to continue the original heating operation after re-activation (for example: the operation is paused at the time when the object-to-be-heated has already been heated to 50° C., if it is desired to heat to 100° C. upon re-activation, the present invention may detect the originally-exhibited temperature and continues the heating operation to reach 100° C., when it automatically shuts down).

(16) It can be seen from a comparison of the present invention to the conventional manually-operating heating technology or barcode-scanning based heating technology that the conventional technology has various shortcomings, such as over-heating or under-heating and may result in high rate of heating failure, but the present invention provides a heating result of the highest efficiency to ensure 100% success of heating.

In summary, the present invention provides a cooking appliance that contains a control program and can operate with a reading device and the sensors mounted in the cooking appliance so that when it is desired to heat a foodstuff, through reading the contents of an object-to-be-identified attached to the object-to-be-heated, the cooking appliance can be driven to carry out automatic heating by following temperature and time set up in the object-to-be-identified and detections made by the sensors, whereby heating or cooking of food is made more convenient. This is a practical and ideal novel invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for executing heating according property of food, comprising:
providing a cooking appliance with a reading device for reading an object-to-be-identified, the cooking appliance having an internal heating zone in which a plurality of sensors is arranged;
attaching an object-to-be-identified that contains temperature, time, and other parameters of water content, humidity, roasting, and smoking to an object-to-be-heated;
mounting a reading device to the cooking appliance;
bringing the object-to-be-heated to a front side of the cooking appliance to allow the reading device of the cooking appliance to scan and read the object-to-be-identified;
the reading device converting the contents of the object-to-be-identified into digital signal and a pre-loaded program of the appliance being compared with the digital signal for temporal storage;
placing the object-to-be-heated in the cooking appliance and activating the cooking appliance to execute a heating process, and
using the sensors to detect a temperature difference between a surface temperature of one point or multiple points or an average of surface temperature and an interior temperature to automatically set up the heating process so that the temperature difference between the surface temperature and the interior temperature is kept constant, whereby when any predetermined value reaches the optimum value, the heating is terminated, thereby making heating or cooking of food more convenient and ensuring practical and optimum result of use.

2. The method for executing heating according property of food according to claim 1, wherein the reading device comprises a barcode scanner that is mounted to the cooking appliance in such a way that a reading terminal is exposed outside the cooking appliance.

3. The method for executing heating according property of food according to claim 1, wherein the object-to-be-identified attached to the object-to-be-heated comprises a barcode.

4. The method for executing heating according property of food according to claim 1, wherein the object-to-be-identified attached to the object-to-be-heated comprises a QR code.

5. The method for executing heating according property of food according to claim 1, wherein the object-to-be-identified attached to the object-to-be-heated comprises an identifiable pattern.

6. The method for executing heating according property of food according to claim 1, wherein the cooking appliance comprises a printing device for printing a barcode or a QR code.

7. The method for executing heating according property of food according to claim 1, wherein the sensors arranged in the heating zone of the cooking appliance comprise temperature detection elements.

8. The method for executing heating according property of food according to claim 1, wherein the sensors of the cooling appliance are respectively set at two lateral sides, a rear side, and a top side of the heating zone.

9. The method for executing heating according property of food according to claim 8, wherein the sensor set at the top side of the heating zone detects an interior temperature of the object-to-be-heated.

10. The method for executing heating according property of food according to claim 8, wherein the sensors set at the two lateral sides and the rear side of the heating zone detect surface temperature of the object-to-be-heated.

11. The method for executing heating according property of food according to claim 1, wherein the cooking appliance comprises a displaying screen to display a heating curve.
